(19) United States
(12) Patent Application Publication
(10) Pub. No.: US 2008/0175137 A1
(43) Pub. Date: Jul. 24, 2008

(54) METHOD FOR ENCODING DATA WRITTEN TO OPTICAL STORAGE MEDIA

(75) Inventors: Wei-Hsiang Tseng, Taipei City (TW); Chia Ping Chen, Hsinchu City (TW); Ching-Wen Hsueh, Yilan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/625,849

(22) Filed: Jan. 23, 2007

(51) Int. Cl. G11B 7/24

(52) U.S. Cl. 369/275.3

(57) ABSTRACT

The invention provides a method for optical storage medium writing. First, raw data is transferred from a host to a primary memory. The primary memory is then read to obtain read-out data. A series of encoding steps are then carried out simultaneously to generate formatted data according to the read-out data. Finally, the formatted data is directly written to an optical storage medium without accessing the primary memory again.

### BACKGROUND OF THE INVENTION

1. Field of the Invention

The invention relates to optical storage media, and more particularly to writing data thereto.

2. Description of the Related Art

Optical storage media have advantages over magnetic storage media, such as higher capacities as removable modules, and not being subject to head crashes or corruption from stray magnetic fields. They also have a 30-year lifetime and are less vulnerable to extremes of temperature. Conventional optical storage media includes compact discs (CD), digital versatile discs (DVD), and blu-ray discs.

FIG. 1 is a flowchart of a conventional method 100 for writing data to optical storage media. First, raw data to be written to an optical disc, such as a CD or a DVD, is transferred from a host to a memory of an optical disc device in step 102. Before the raw data is written to the optical disc, it must be converted to a format suitable for storage in advance through a series of encoding steps. For example, some of the encoding steps may generate an error detection code (EDC) detecting data error, and an error correction code (ECC) for calibrating the data error. The encoding steps may also convert the raw data into the formatted data through interleaving or other algorithms.

Encoding steps must then be executed on the raw data stored in the memory. Thus, the memory is read to obtain read-out data in step 104. One of the encoding steps is then carried out according to the read-out data in step 106, and the encoded data generated by the encoding steps is stored back to the memory. Since generation of the formatted data requires multiple encoding steps, steps 104 and 106 are repeated if some encoding steps remain unexecuted in step 108. Thus, the memory of the optical disc drive is accessed again each time an encoding step is executed. After all encoding steps are executed, the memory is read to obtain the formatted data in step 110, and the formatted data is written to the optical disc in step 112.

FIG. 2 is a schematic diagram showing a conventional system 200 for writing data to optical storage media according to method 100 of FIG. 1. The system 200 includes a host 210, a memory 220 of an optical disc drive, an encoder 230 of the optical disc drive, and a optical disc 240. Writing of raw data to the optical disc 240 can be divided into a first phase, in which the host 210 transfers the raw data to the memory 220 of the optical disc drive, as shown in FIG. 2A, a second phase, in which the encoder 230 repeatedly accesses the memory 220 to implement a plurality of encoding steps, as the cycle of steps 104, 106 and 108, and the encoded data is stored back to the memory 220, as shown in FIG. 2B. Every time the encoder 230 executes an encoding step, the memory 220 is accessed once. After all encoding steps are complete, the raw data is converted to formatted data suitable for storage. Encoder 230 reads the formatted data from the memory 220 and in a third and final phase, writes the formatted data to the optical disc 240, as shown in FIG. 2C.

Because the memory of the optical disc drive is accessed again whenever one of the encoding steps is executed, and memory access requires a lot of time, frequent memory access delays the data writing process. The bandwidth of the optical disc drive, or the data amount which can be written to the optical disc in a predetermined period, is reduced, and system performance degraded.

### BRIEF SUMMARY OF THE INVENTION

The invention provides a method for optical storage medium writing. First, raw data is transferred from a host to a primary memory. The primary memory is then read to obtain read-out data. A series of encoding steps are then carried out simultaneously to generate formatted data according to the read-out data. Finally, the formatted data is directly written to an optical storage medium without accessing the primary memory again.

The invention also provides a method for optical storage medium writing. First, raw data is transferred from a host to a primary memory. The raw data is then received to obtain received data without accessing the primary memory. A series of encoding steps are then carried out simultaneously according to the received data to generate formatted data. Finally, the formatted data is written to an optical storage medium.

The invention provides an apparatus for optical storage medium writing. The apparatus comprises a primary memory and an encoder. The primary memory stores raw data transferred from a host. The encoder reads the primary memory to obtain read-out data, carries out a series of encoding steps simultaneously to generate formatted data according to the read-out data; and directly writes the formatted data to an optical storage medium without accessing the primary memory again.

The invention also provides an apparatus for optical storage medium writing. The apparatus comprises a primary memory and an encoder. The primary memory stores raw data transferred from a host. The encoder receives the raw data to obtain received data without accessing the primary memory, carries out a series of encoding steps simultaneously according to the received data to generate formatted data, and writes the formatted data to an optical storage medium.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of a conventional method for writing data to optical storage media;

FIGS. 2A, 2B and 2C show three phases of writing data to optical storage media in a conventional system according to method 100 of FIG. 1;

FIG. 3 is a flowchart of a method for writing data to optical storage media according to the invention;

FIGS. 4A and 4B show two phases of writing data to optical storage media in a system according to the method in FIG. 3;

FIG. 5 is a flowchart of another method for writing data to optical storage media according to the invention;

FIGS. 6A and 6B show two phases of writing data to optical storage media in a system according to the method in FIG. 5;

FIGS. 7A and 7B show two phases of writing data to optical storage media in a system according to both the methods in FIG. 3 and FIG. 5;

FIG. 8A shows a frame format of a CD;

FIG. 8B shows original memory access sequences of original encoding steps for encoding CD data;

FIG. 8C shows an example of the partial parity encoding method for encoding Q-Parity;

FIG. 9A is a flowchart of a method for writing data to a CD according to the invention;

FIG. 9B is a flowchart of another method for writing data to a CD according to the invention;

FIGS. 10A and 10B show the frame format of a blu-ray disc;

FIG. 10C shows the original memory access sequences of the original encoding steps for encoding blu-ray disc data;

FIG. 11A is a flowchart of a method for writing data to a blu-ray disc according to the invention;

FIG. 11B is another flowchart of a method for writing data to a blu-ray disc according to the invention;

FIG. 12A shows the frame format of a DVD;

FIG. 12B shows the original memory access sequences of the original encoding steps for encoding DVD data;

FIG. 12C shows the generated PO-parity row-interleaved between the raw data;

FIG. 13 is a flowchart of a method for writing data to a DVD according to the invention;

FIG. 14A is a schematic diagram of a conventional method for writing data to a DVD disc;

FIG. 14B is a schematic diagram of a method for writing data to a DVD disc according to the invention, wherein a scrambling step is combined with data encoding;

FIG. 15A is a schematic diagram of a conventional method for writing data to a DVD disc; and

FIG. 15B is a schematic diagram of a method for writing data to a DVD disc according to the invention, wherein a scrambling step is combined with data encoding.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

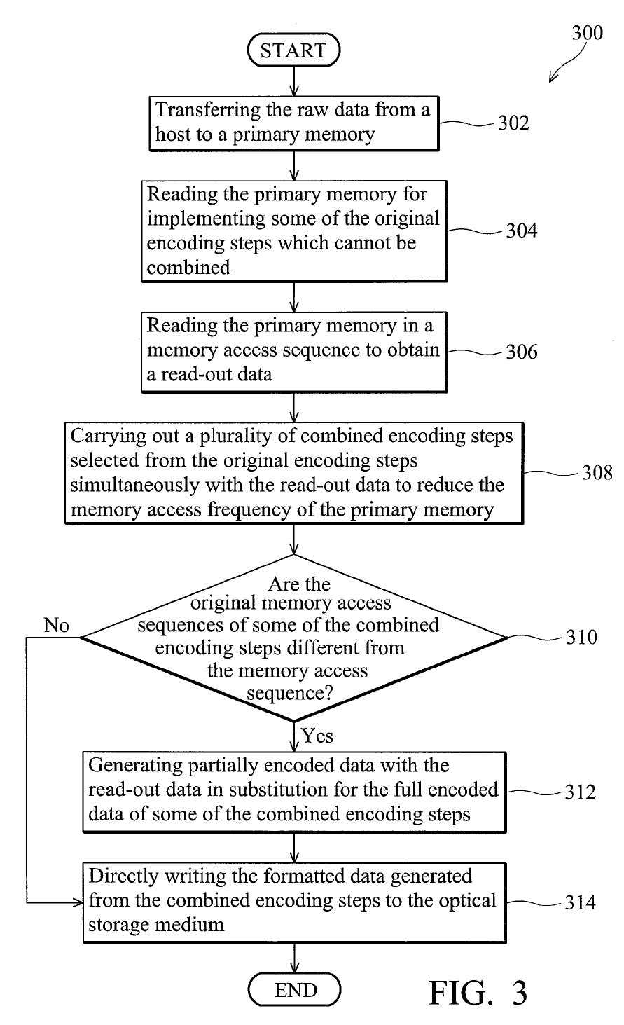

FIG. 3 is a flowchart of a method 300 for writing data to optical storage media according to the invention, wherein simultaneous execution of encoding steps with only a single memory access provides reduced system latency with corresponding improvement of system performance. In addition, direct writing of formatted data encoded by the most recent encoding step to the optical disc, further reduces memory access, whereby system performance is improved.

First, raw data is transferred from a host to a primary memory of an optical disc drive in step 302. Certain original encoding steps are selected and carried out together according to the read-out data of a single memory access. The selected encoding steps are distinguished from the other original encoding steps. With writing of the formatted data to the optical storage medium incorporated into the combined encoding steps in method 300, the combined encoding steps are selected in favor of a combination of the combined encoding steps and formatted data writing.

Before the combined encoding steps are carried out, the remainder of the original encoding steps is executed in advance in step 304. Primary memory is then read in a memory access sequence to obtain read-out data in step 306. The memory access sequence may be identical to the sequence in which the most recent original encoding step accessed the primary memory, so that formatted data generated by the most recent encoding step is directly written to the optical disc. The combined encoding steps are then carried out simultaneously with the read-out data in step 308, with access to the primary memory reduced by (N−1) times if the number of the combined encoding steps is N, compared with the cycle of steps 104, 106 and 108 of method 100.

If original memory access sequences of the combined encoding steps, however, are different from each other, the combined encoding steps cannot be implemented simultaneously in step 308, since read-out data is generated in a single memory access sequence. In this situation, combined encoding steps with different memory access sequence from the read-out data can generate partially encoded data, such as partial parity, with the read-out data in step 312 to substitute for the full encoded data of the combined encoding steps. Because method 300 combines the combined encoding steps and the formatted data writing, the formatted data generated from the combined encoding steps is directly written to an optical storage medium in step 314. Thus, the access to the primary memory is further reduced by one, compared with the steps 110 and 112 of method 100. Thus, compared with method 100, the memory access of method 300 is totally reduced by N times, and data processing bandwidth increased commensurately.

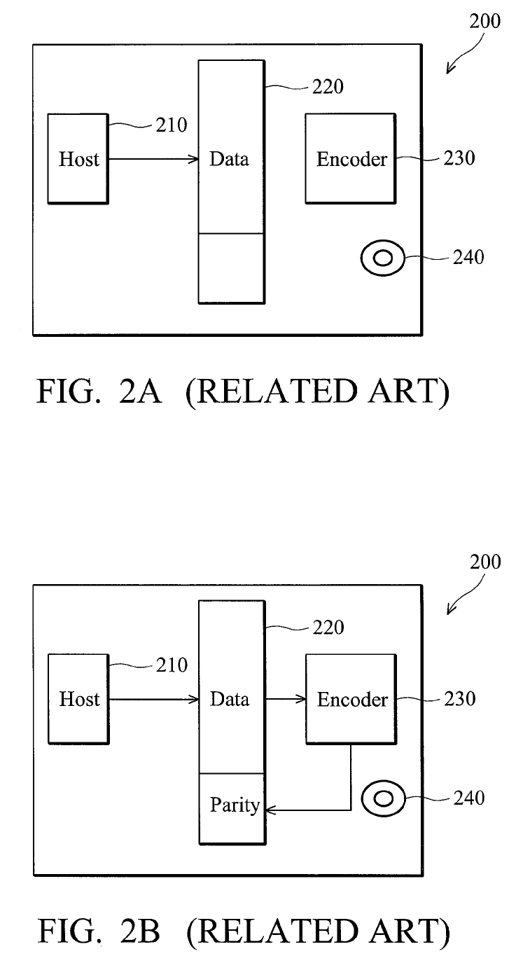

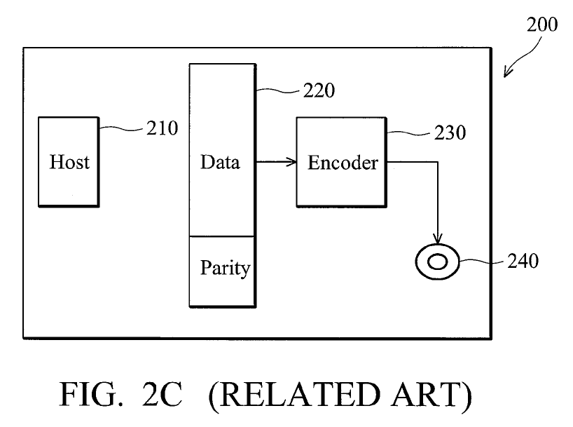

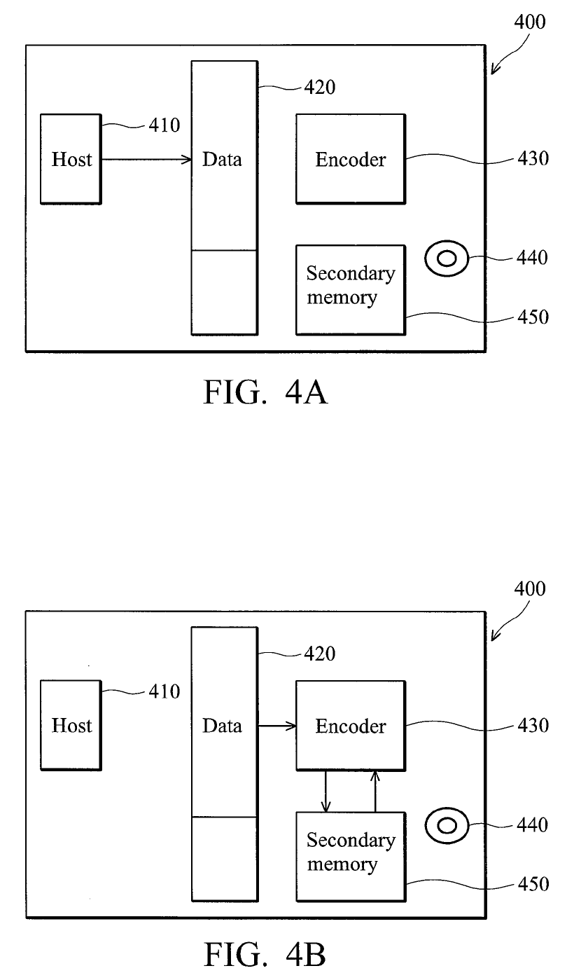

FIG. 4 is a schematic diagram showing a system 400 for writing data to optical storage media according to the invention. The system 400 includes a host 410, a memory 420 of an optical disc drive, an encoder 430 of the optical disc drive, an optical disc 440, and a secondary memory 450. The process of writing raw data to the optical disc 440 can be divided into two phases, the first phase of FIG. 4A and the second phase of FIG. 4B. Although the first phase of FIG. 4A is similar to the first phase of FIG. 2A, the second phase of FIG. 4B combines the second and third phases of FIGS. 2B and 2C according to method 300. In addition, the encoding steps of FIG. 4B are executed together, unlike the respective execution of the encoding steps of FIG. 2B.

In the first phase, the host 410 transfers the raw data to the primary memory 420, as shown in FIG. 4A. In the second phase, the encoder 430 reads the primary memory 420 in a memory access sequence to obtain read-out data, and carries out a plurality of encoding steps simultaneously with the read-out data to generate the formatted data, in steps 306 and 308 of method 300. If the original memory access sequences of some encoding steps are different from the memory access sequence in which the read-out data is generated, the encoder 430 generates partially encoded data with the read-out data, in steps 310 and 312. The partially encoded data is stored into the secondary memory 450. When the formatted data is generated, it is directly written by the encoder 430 to the optical disc 440, as shown in FIG. 4B. Thus, the memory access of system 400 is reduced compared with system 200.

Method 300 combines the data writing process with the encoding process to reduce memory access. Further memory access reduction can be accomplished by, for example, when the raw data is transferred to the primary memory in step 302, primary memory being accessed once. If the transfer of raw data is combined with the combined encoding steps, memory access is further reduced.

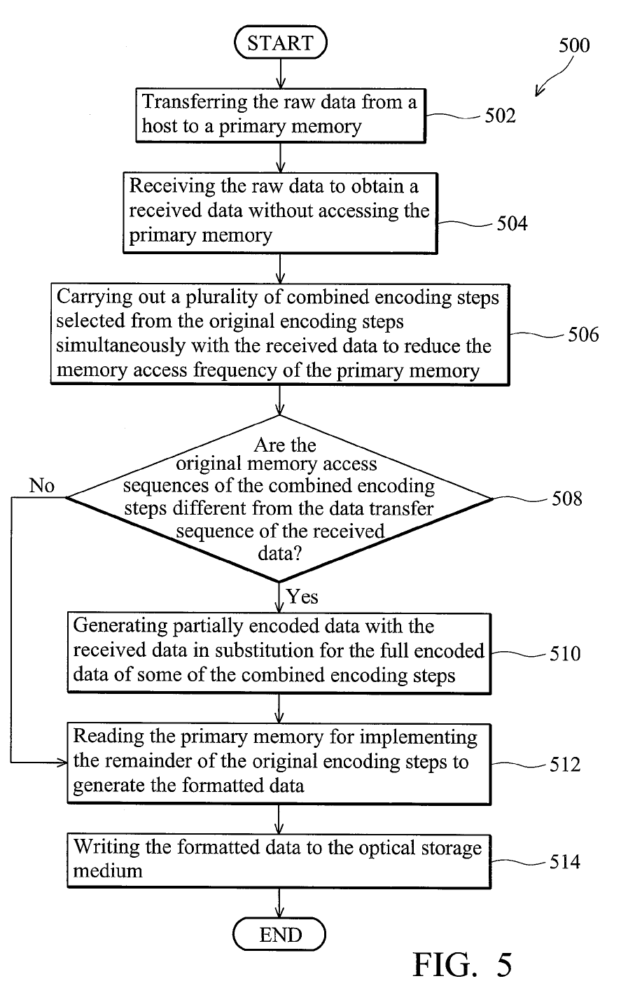

FIG. 5 is a flowchart of a method 500 for writing data to optical storage media according to the invention. First, raw data is transferred from a host to a primary memory of an optical disc drive in step 502. Unlike method 300, when the raw data is transferred to the primary memory, the raw data is concurrently received to obtain received data in step 504 without accessing the primary memory. Combined encoding steps may be selected in favor of the combination of the original encoding steps and transfer of the raw data. The combined encoding steps are then carried out simultaneously with the received data in step 506. Because the combined encoding steps are executed with a single memory access, access to the primary memory is reduced by (N−1) times if the number of the combined encoding steps is N, compared with the cycle of steps 104, 106 and 108 of method 100.

The raw data is transferred in a data transfer sequence in step 502. Thus, the combined encoding steps of step 506 must be implemented according to the data transfer sequence of the received data. If the original memory access sequences of certain combined encoding steps different from the data transfer sequence in step 508, the combined encoding steps generate partially encoded data with the received data to substitute for the full encoded data in step 510. The remainder of the original encoding steps is then executed to generate the formatted data in step 512. The formatted data is then written to the optical storage medium in step 514. Because method 500 combines the combined encoding steps and the data transfer of step 502, access to the primary memory is further reduced by one, compared with steps 102 and 104 of method 100. Thus, compared with method 100, the memory access of method 500 is totally reduced by N times, and data processing bandwidth increased as latency of memory access is decreased.

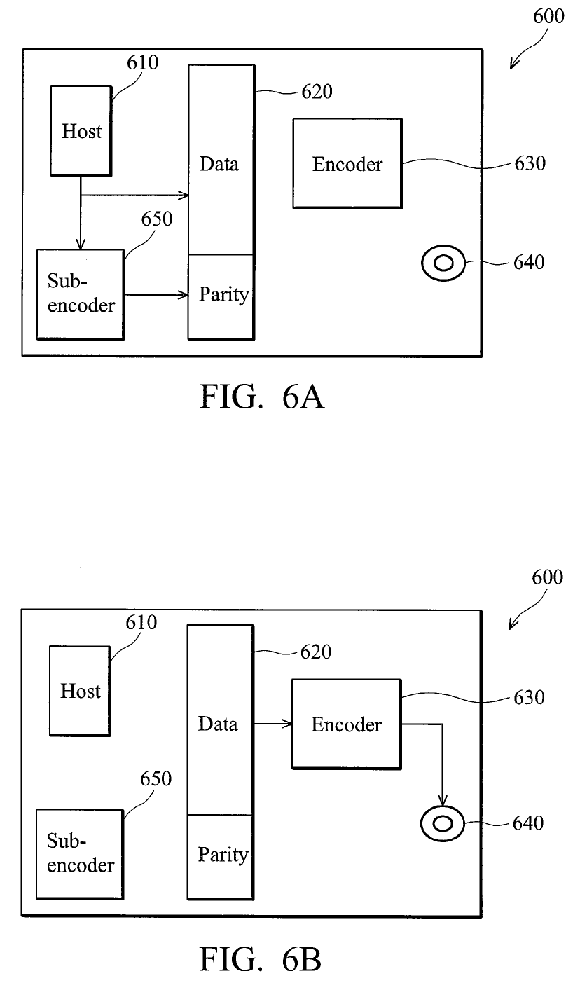

FIG. 6 is a schematic diagram showing a system 600 for writing data to optical storage media according to the invention. The system 600 includes a host 610, a sub-encoder 650, a memory 620 of an optical disc drive, an encoder 630 of the optical disc drive, and an optical disc 640. The process of writing raw data to the optical disc 640 can be divided into a first phase, as shown in FIG. 6A and a second, as shown in FIG. 6B. Although the second phase of FIG. 6B is similar to the third phase of FIG. 2B, the first phase of FIG. 6A combines the first and second phases of FIGS. 2A and 2B according to method 500. In addition, the encoding steps of FIG. 6A are executed together, unlike the respective execution of the encoding steps of FIG. 2B.

In the first phase, the host 610 transfers the raw data to the primary memory 620, as shown in FIG. 6A. Concurrently, raw data is received by the sub-encoder 650 to obtain received data, according to which a plurality of combined encoding steps are implemented together to generate encoded data stored in the primary memory 620, in steps 504 and 506 of method 500. If the original memory access sequences of certain combined encoding steps are different from the data transfer sequence of the received data, the sub-encoder 650 generates partially encoded data with the received data, in steps 508 and 510. In the second phase, the encoder 630 reads the primary memory 620 to implement the remainder of the original encoding steps, thereby generating the formatted data. The formatted data is then written to the optical disc 640, as shown in FIG. 6B.

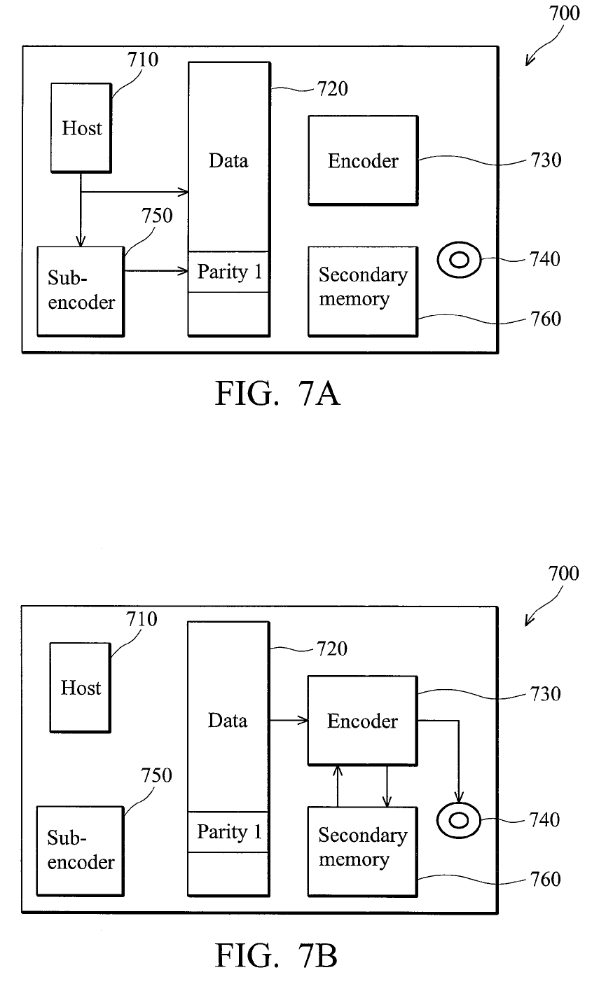

Method 300 and method 500 can be combined, whereby the encoding steps are respectively combined with the raw data transfer and the writing of the formatted data, thereby reducing the memory access. FIG. 7 is a schematic diagram showing a system 700 for writing data to optical storage media according to the invention. In the first phase, several encoding steps are combined with the raw data transfer, as the first phase of FIG. 6A. In the second phase, the other encoding steps are combined with the writing of the formatted data, as the second phase of FIG. 4B.

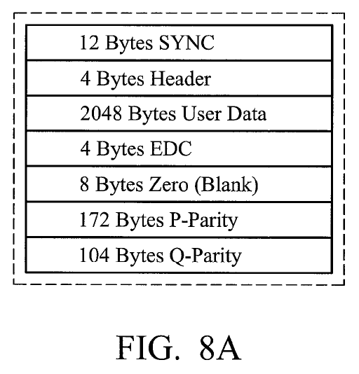

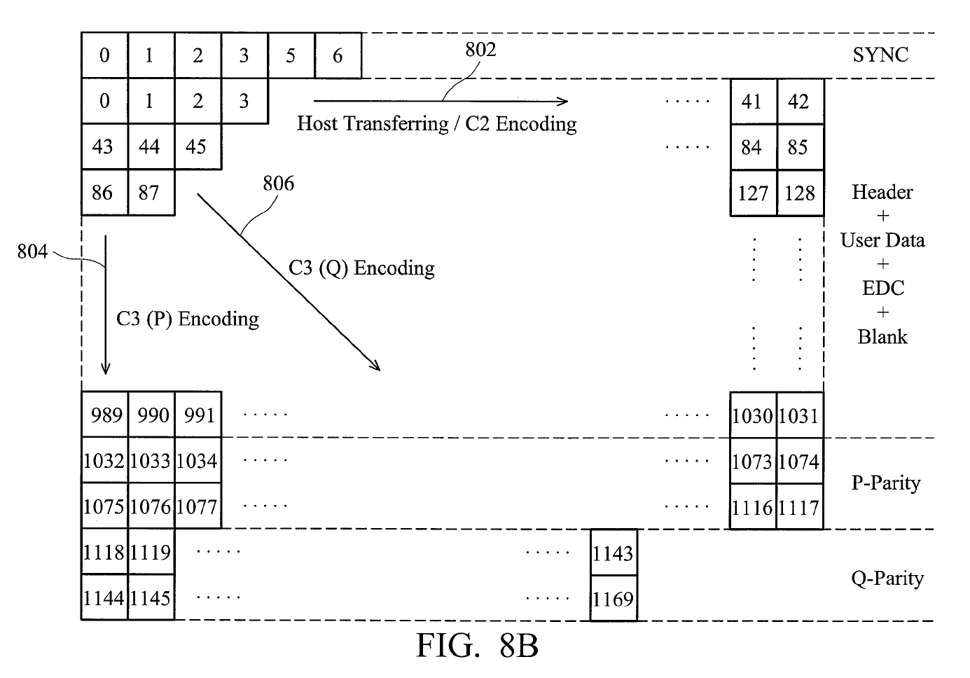

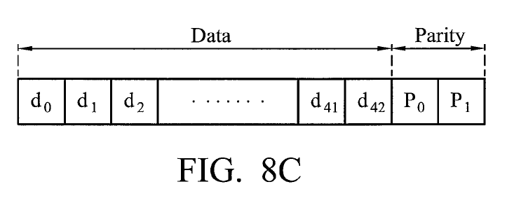

In the following, methods 300 and 500 of the invention will be further explained according to the type and data format of optical storage media, such as CD, blu-ray disc, and DVD. The first discussed optical storage media type is CD. FIG. 8A shows a frame format of a compact disc (CD). The data frame of a CD includes sync data, header, user data, error detection code (EDC), blank, P-parity and Q-parity. Among the fields of the CD data frame, only the user data field directly holds the raw data. Thus, before the formatted data conforming to the CD data frame is written to a CD disc, a CD drive has to derive other fields of the CD data frame from the raw data.

Because the raw data has to be converted to the formatted data conforming to the CD data frame shown in FIG. 8A, methods 300 and 500 can be used to generate the formatted data while the formatted data is written to a CD disc. According to the CD data frame shown in FIG. 8A, a conventional method for writing data to a CD includes at least the original encoding steps of an error detection code (EDC) encoding step, a P-parity encoding step, a Q-parity encoding step, and a C2 level encoding step of Cross-Interleaved Reed-Solomon Coding (CIRC). The original memory access sequences of the original encoding steps for encoding CD data are shown in FIG. 8B. Arrows 804 and 806 respectively indicate the directions of the original memory access sequences of the P-parity encoding step and the Q-parity encoding step. Arrow 802 indicates the direction of the original memory access sequences of the C2 level encoding step and the data transfer sequence from a host to a primary memory of the CD drive.

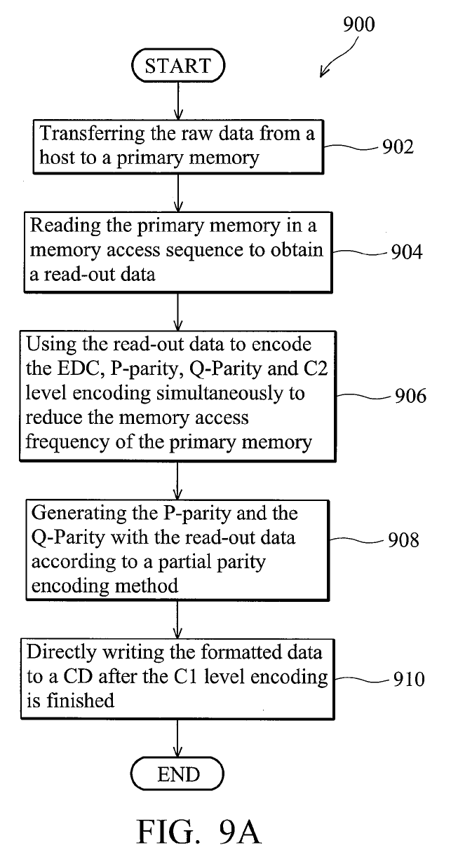

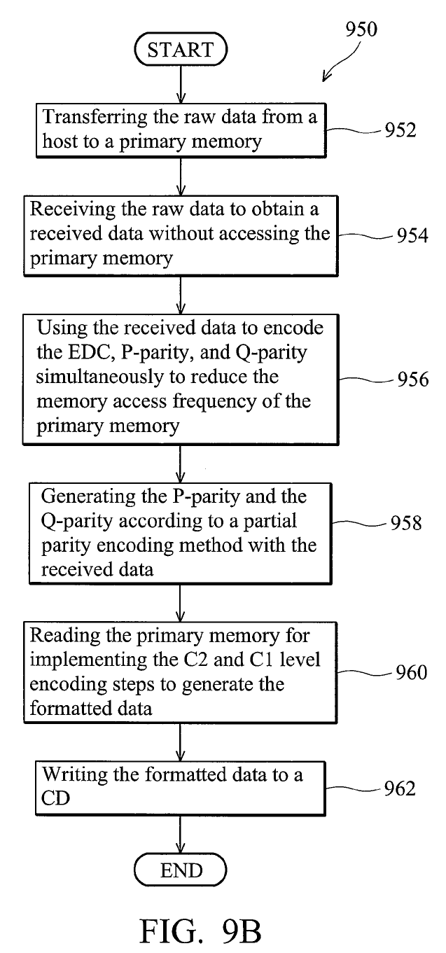

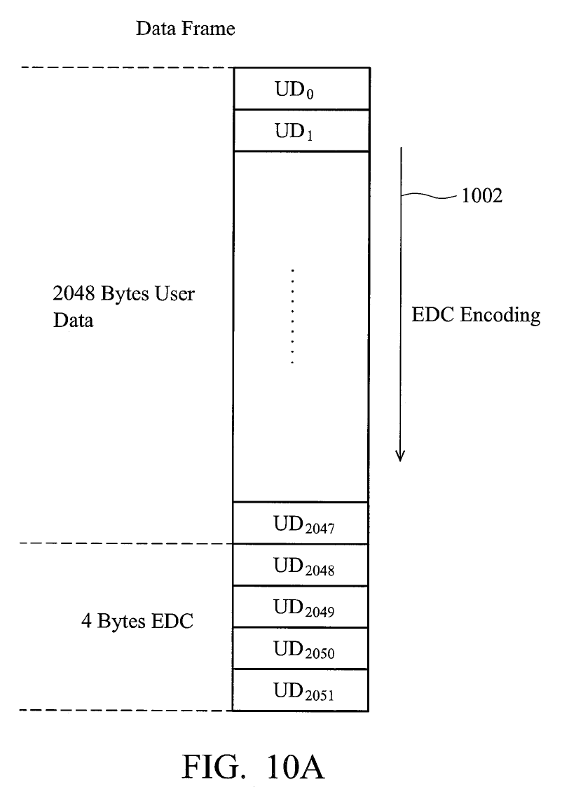

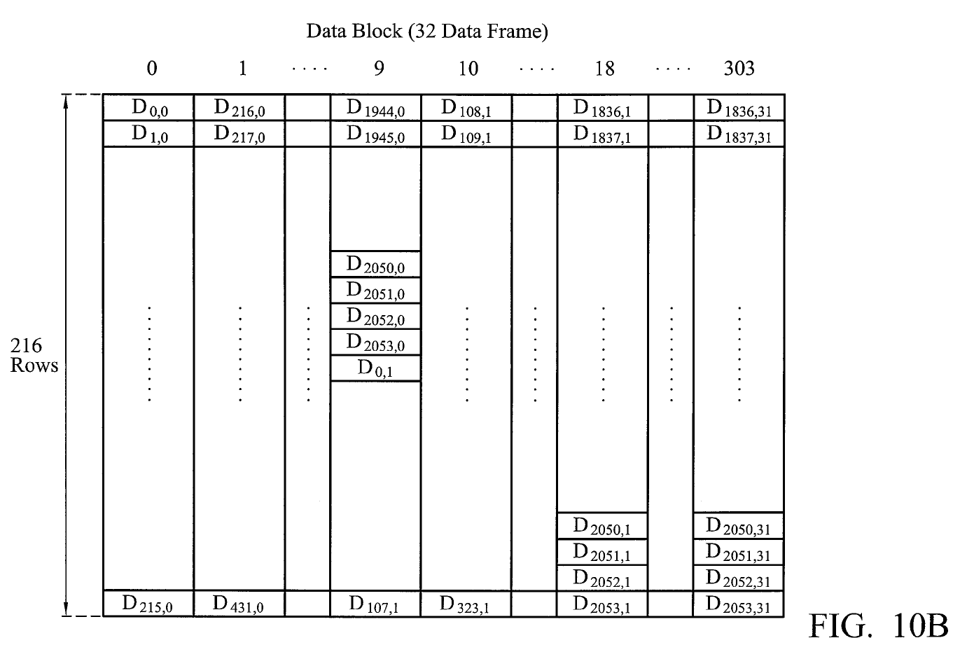

FIG. 9A is a flowchart of a method 900 for writing data to a CD according to the invention. Method 900 is an embodiment of method 300, which combines the original encoding steps to be executed with the writing of data to the CD in single memory access. First, the raw data is transferred from a host to a primary memory of the CD drive in step 902. The primary memory is then read in step 904 to obtain read-out data, wherein the memory access sequence is the memory address sequence. The read-out data is used to encode the EDC, P-parity, Q-Parity and C2 level encoding simultaneously in step 906. The original memory access sequences of the P-parity encoding step and the Q-parity encoding step, however, are not the same as the memory address sequence. Thus, the P-parity and the Q-Parity are generated with the read-out data in step 908 according to a partial parity encoding method. Finally, after the C1 level encoding is finished to generate the formatted data, the formatted data is directly written to a CD in step 910. There are only two accesses to the primary memory (steps 902 and 904) in method 900, such that total memory access is reduced.

FIG. 9B is a flowchart of a method 950 for writing data to a CD according to the invention. Method 950 is an embodiment of method 500, which combines the original encoding steps to be executed with transfer of data from the host. First, the raw data is transferred from a host to a primary memory of the CD drive in step 952. The raw data is then received in step 954 without accessing the primary memory. The received data is then used to encode the EDC, P-parity, and Q-parity simultaneously in step 956. The original memory access sequences of the P-parity encoding step and the Q-parity encoding step, however, are not the same as the data transfer sequence. Thus, the P-parity and the Q-Parity are generated with the read-out data in step 958 according to a partial parity encoding method. The primary memory is read in step 960 to implement the C2 and C1 level encoding steps to generate the formatted data. Finally, the formatted data is written to a CD in step 962. There are only two accesses to the primary memory (steps 952 and 960) in method 950, such that total memory access is reduced.

FIG. 8C shows an example of the partial parity encoding method for encoding Q-Parity. The parity P₀ and P₁ is to be the Q-parity of the raw data d₀˜d₄₂. The partial Q-parity can then be encoded according to the following algorithm:

parity=d₀(x⁴⁴ mod g(x))+d₁(x⁴³ mod g(x))+ . . . +d₄₁(x³ mod g(x))+d₄₂(x² mod g(x));

wherein the parity is (P₀x+P₁), the g(x) is a generator polynomial equaling ((x−α⁰)(x−α¹)), and α is the root of the primitive polynomial p(x) equaling (x¹+x⁴+x²+1).

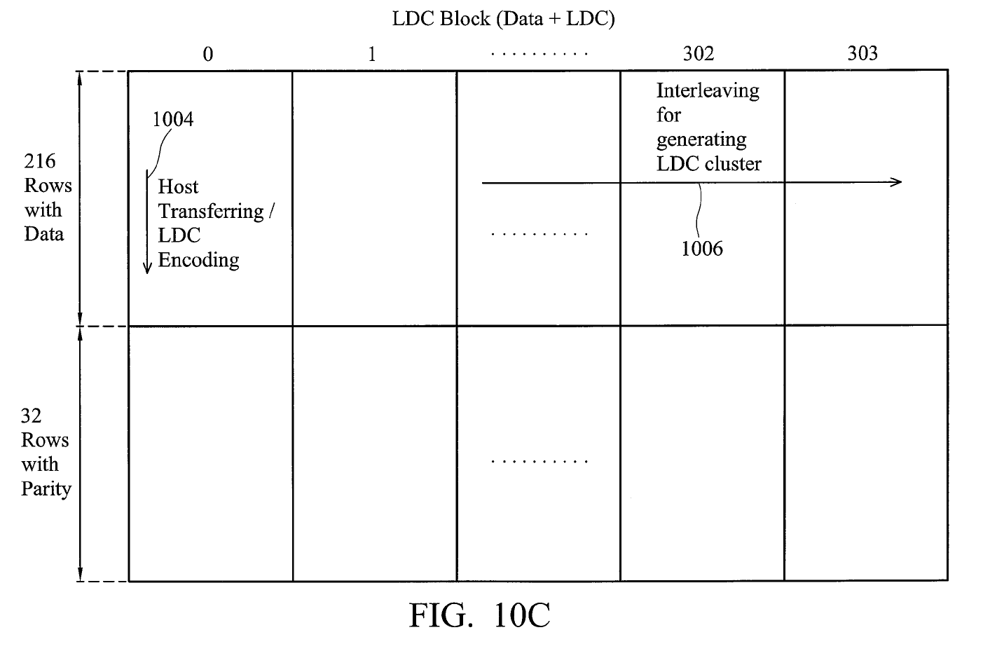

FIG. 10A and 10B show the frame format of a blu-ray disc. Four bytes of error detection code are generated according to every 2048 bytes of user data. Before the formatted data conforming to the blu-ray disc data frame is written to a blu-ray disc, at least three encoding steps including a EDC encoding step, a long distance Reed-Solomon code (LDC) encoding step, and an interleaving step are required to convert the raw data to formatted data conforming to the blu-ray disc data frame, generated in methods 300 and 500. The original memory access sequences of the original encoding steps for encoding blu-ray disc data are shown in FIG. 10A and FIG. 10C. Arrows 1002 and 1004 indicate the direction of the original memory access sequences of the EDC encoding step and the LDC encoding step and the data transfer sequence from a host to a primary memory of the blu-ray disc drive. Arrow 1006 indicates the direction of the original memory access sequences of the interleaving step.

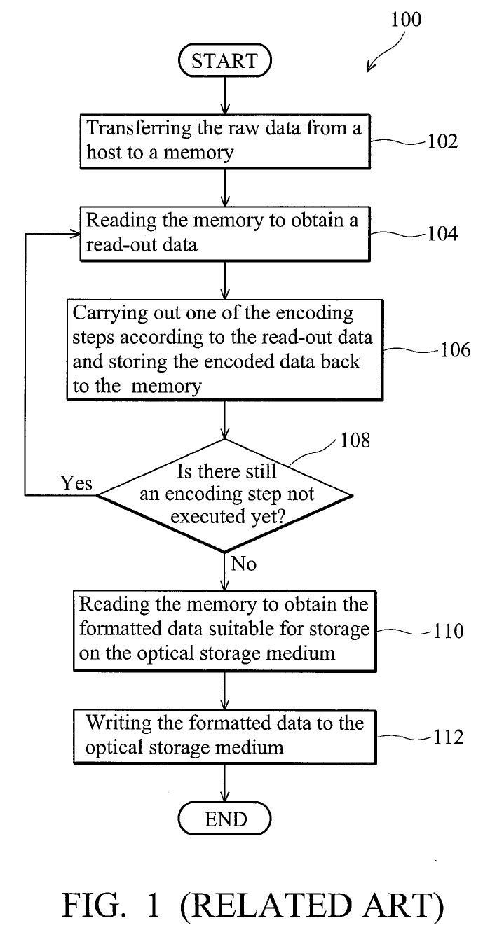

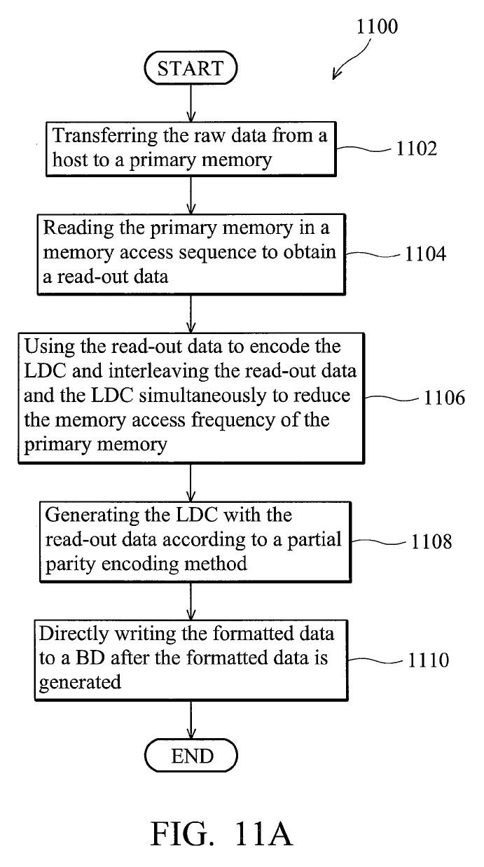

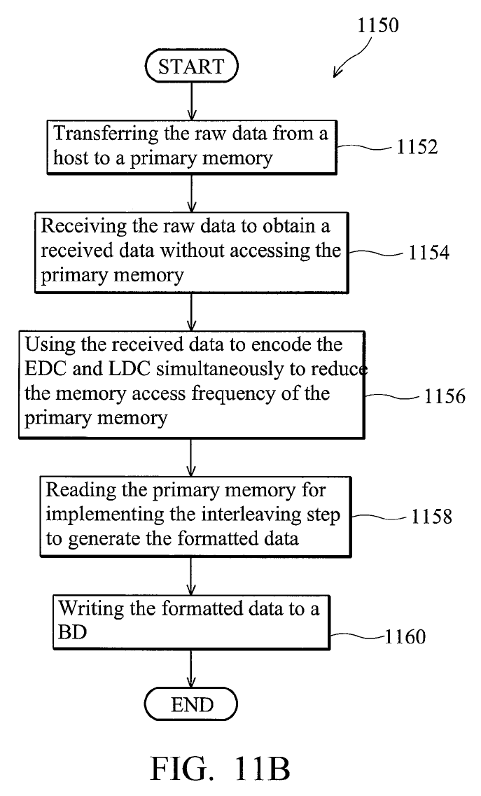

FIG. 1A is a flowchart of a method 1100 for writing data to a blu-ray disc according to the invention. Method 1100 is an embodiment of method 300, which combines the original encoding steps to be executed with the writing of data to the blu-ray disc through a single memory access. First, the raw data is transferred from a host to a primary memory of the blu-ray disc drive in step 1102. The primary memory is then read in step 1104 to obtain read-out data, utilizing the memory access sequence of the interleaving step. The read-out data is used to encode the LDC and to interleave the read-out data and the LDC simultaneously in step 1106. The original memory access sequence of the LDC encoding step, however, is not the same as the memory access sequence of the interleaving step. Thus, the LDC is generated with the read-out data in step 1108 according to a partial parity encoding method. Finally, after the formatted data is generated, it is directly written to a blu-ray disc in step 1110. There are only two accesses to the primary memory (steps 1102 and 1104) in method 1100. Additionally, because the data transfer sequence of the raw data is the same as the memory access sequence of the EDC and LDC encoding steps, the encoding steps are executed with data transfer from the host. FIG. 11B is a flowchart of a method 1150 for writing data to a blu-ray disc according to the invention, wherein method 1150 is an embodiment of method 500. It can be seen that there are only two accesses to the primary memory (steps 1152 and 1158) in method 1150, such that total memory access is reduced.

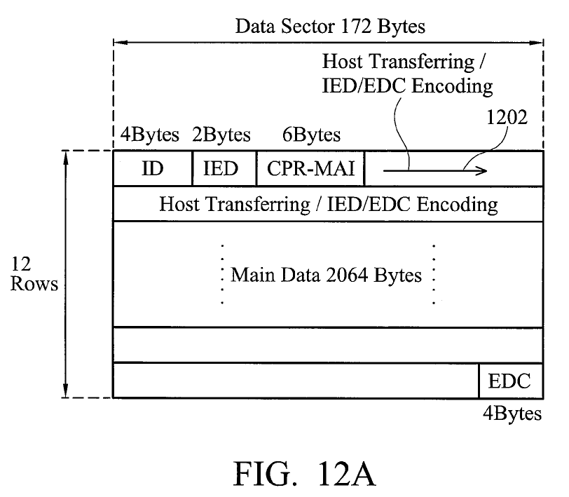

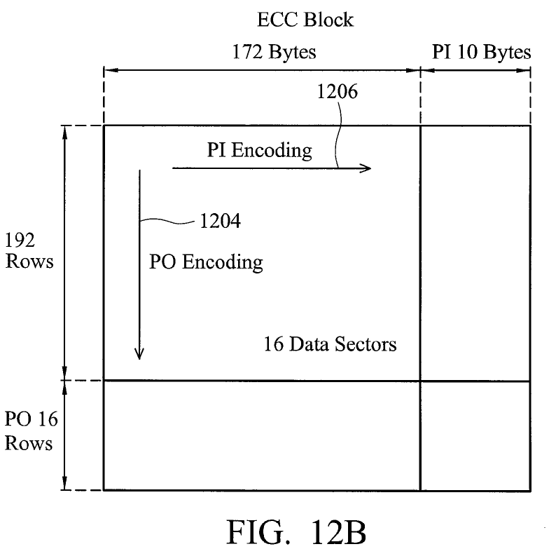

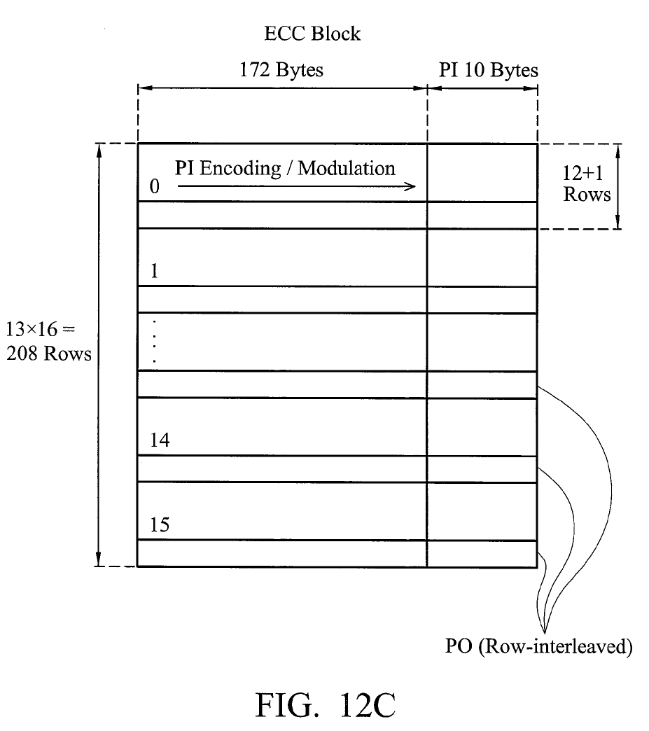

FIG. 12A shows the frame format of a digital versatile disc (DVD). Before the formatted data conforming to the DVD data frame is written, an ID error detection code (IED) and error detection code (EDC) encoding step, a parity of the outer code (PO-parity) encoding step, and a parity of the inner code (PI-parity) encoding step are required to convert the raw data to formatted data. Accordingly, methods 300 and 500 can generate the formatted data while the formatted data is written to a DVD disc. The original memory access sequences of the original encoding steps for encoding DVD data are shown in FIG. 12A and FIG. 12B. Arrows 1202 indicate the direction of the original memory access sequences of the IED and EDC encoding step and the data transfer sequence from a host to a primary memory of the DVD drive. Arrows 1204 and 1206 respectively indicate the directions of the original memory access sequences of the PO-parity encoding step and the PI-parity encoding step. The generated PO-parity is row-interleaved between the raw data, as shown in FIG. 12C.

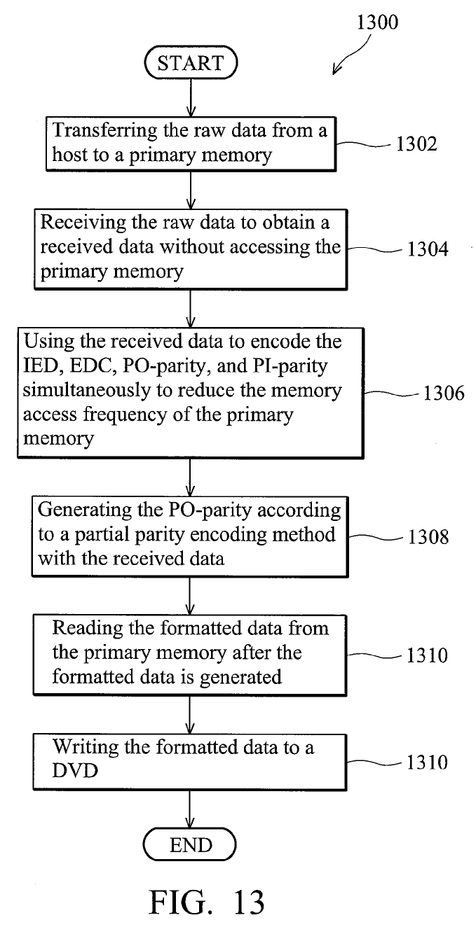

FIG. 13 is a flowchart of a method 1300 for writing data to a DVD disc according to the invention. Method 1300 is an embodiment of method 500, which combines the original encoding steps to be executed with data transfer from the host. First, the raw data is transferred from a host to a primary memory of the DVD drive in step 1302, wherein the data transfer sequence is the memory address sequence. The raw data is then received in step 1304 without accessing the primary memory. The received data is then used to encode the IED, EDC, PO-parity, and PI-parity simultaneously in step 1306. The original memory access sequences of the PO-parity encoding step, however, are not the same as the data transfer sequence. Thus, the PO-parity is generated with the read-out data in step 1308 according to a partial parity encoding method. The formatted data is then read in step 1310 from the primary memory. Finally, the formatted data is written to a DVD disc in step 1312. There are only two accesses to the primary memory (steps 1302 and 1310) in method 1300, such that total memory access is reduced.

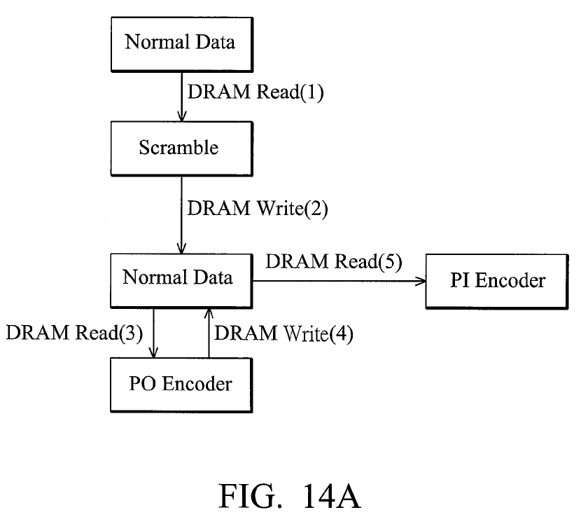

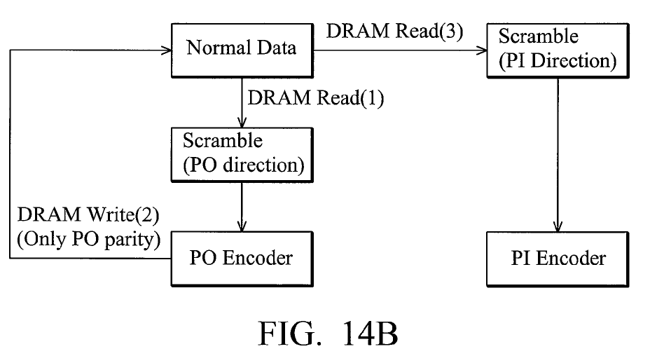

When conversion from the raw data to the formatted data includes a scrambling step, the scrambling step may also be combined with the encoding steps. FIG. 14A is a schematic diagram of a conventional method for writing data to a DVD disc. First, normal data is read from the memory and scrambled (DRAM read (1)), and the scrambled normal data is written to the memory (DRAM write (2)). The scrambled normal data is then read from the memory again to generate PO parity (DRAM read (3)), and the PO parity is written back to the memory (DRAM write (4)). Finally, the scrambled normal data and the PO parity are read from the memory to generate PI parity and implement modulation (DRAM read (5)).

FIG. 14B is a schematic diagram of a method for writing data to a DVD disc according to the invention. First, normal data is read from the memory (DRAM read(1)), and scrambled to generate PO parity. The PO parity is then written back to the memory (DRAM write(2)). The PO parity and the normal data are read from the memory (DRAM read(3)), and then scrambled to generate PI parity. Comparing the method of the invention shown in FIG. 14B with the conventional method shown in FIG. 14A, there are only 3 memory accesses, compared to 5 in the conventional method, such that memory access is reduced when encoding steps are combined with the scrambling step, and system performance is thus improved.

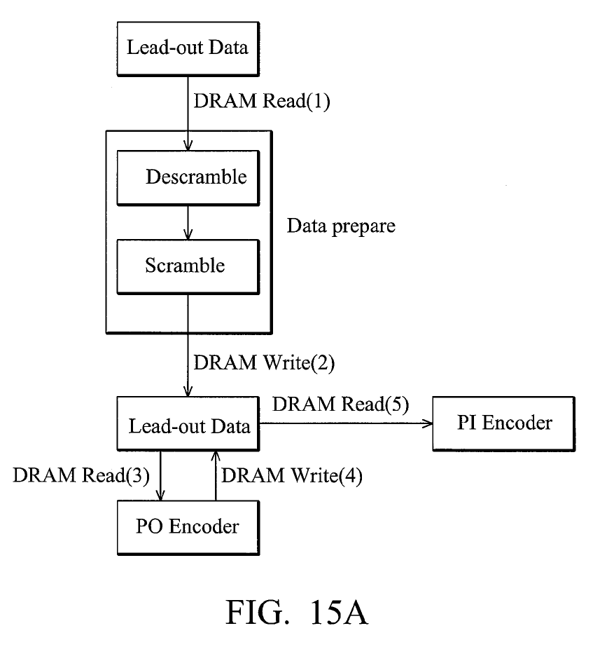

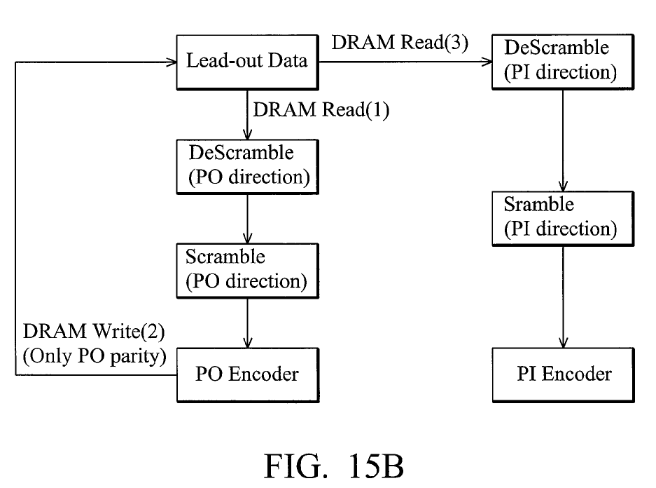

FIG. 15A is a schematic diagram of another conventional method for writing data to a DVD disc. Before the raw data is stored in the memory, it is scrambled to lead-out data by the host, the method differing from that of FIG. 14A. First, the lead-out data is read from the memory (DRAM read (1)), de-scrambled, modified and scrambled again to generate the scrambled lead-out data, and the scrambled lead-out data is written to the memory (DRAM write (2)). The scrambled lead-out data is then read from the memory again to generate PO parity (DRAM read (3)), and the PO parity is written back to the memory (DRAM write (4)). Finally, the scrambled lead-out data and the PO parity are read from the memory to generate PI parity and implement modulation (DRAM read (5)).

FIG. 15B is a schematic diagram of a method for writing data to a DVD disc according to the invention. Unlike FIG. 15A, here the raw data has been scrambled to lead-out data by the host before storage in memory. First, the lead-out data is read from the memory (DRAM read(1)), de-scrambled, modified and scrambled again to generate PO parity. The PO parity is then written back to the memory (DRAM write(2)). The PO parity and the lead-out data are then read from the memory (DRAM read(3)), de-scrambled, modified and scrambled again to generate PI parity. Compared with the conventional method shown in FIG. 14A, there are only 3 memory accesses here, compared to 5 in the conventional method, such that memory access is reduced and system performance improved.

The invention provides a method for writing data to optical storage media, in which certain encoding steps are combined to be executed through single memory access. The encoding steps can be further combined with the data transfer process from host or the data writing process to the optic storage media, or a scrambling step. Thus, memory access is reduced and data processing bandwidth increased, improving system performance.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for optical storage medium writing, comprising:
transferring raw data from a host to a primary memory;
reading the primary memory to obtain read-out data;
carrying out a series of encoding steps simultaneously to generate formatted data according to the read-out data; and
directly writing the formatted data to the optical storage medium without accessing the primary memory again;
wherein the raw data must be converted in advance to the formatted data through the encoding steps before the formatted data is written to the optical storage medium.

2. The method as claimed in claim 1, wherein the read-out data is obtained by reading the primary memory in a memory access sequence, and some of the encoding steps of which the original memory access sequences are different from the memory access sequence generate partially encoded data according to the read-out data.

3. The method as claimed in claim 2, wherein the partially encoded data is stored in a secondary memory.

4. The method as claimed in claim 1, wherein the raw data is converted to the formatted data through a scrambling step in addition to the encoding steps, and the encoding steps and the scrambling step are further carried out simultaneously according to the read-out data.

5. The method as claimed in claim 1, wherein the optical storage medium is a compact disc (CD), and the encoding steps include an error detection code (EDC) encoding step, an error correction code encoding step, a P-parity encoding step, a Q-parity encoding step, and a C2 level encoding step of Cross-Interleaved Reed-Solomon Coding (CIRC), wherein the error correction code encoding step comprises the P-parity encoding step and the Q-parity encoding step.

6. The method as claimed in claim 5, wherein the P-parity of the P-parity encoding step and the Q-parity of the Q-parity encoding step are generated according to a partial parity encoding method.

7. The method as claimed in claim 1, wherein the optical storage medium is a blu-ray disc, and the encoding steps include a long distance Reed-Solomon code (LDC) encoding step and an interleaving step.

8. The method as claimed in claim 7, wherein the LDC encoding step is generated according to a partial parity encoding method.

9. The method as claimed in claim 1, wherein the optical storage medium is a digital versatile disc (DVD).

10. A method for optical storage medium writing, comprising:
transferring raw data from a host to a primary memory;
receiving the raw data to obtain received data without accessing the primary memory;
carrying out a series of encoding steps simultaneously according to the received data to generate formatted data; and
writing the formatted data to an optical storage medium;
wherein the raw data must be converted in advance to the formatted data through the encoding steps before the formatted data is written to the optical storage medium.

11. The method as claimed in claim 10, wherein the received data is obtained in a data transfer sequence in which the host transfers the raw data, and some of the encoding steps of which the original memory access sequences are different from the data transfer sequence generate partially encoded data according to the received data.

12. The method as claimed in claim 10, wherein the optical storage medium is a compact disc (CD), and the encoding steps include an error detection code (EDC) encoding step, an error correction code encoding step, a P-parity encoding step, and a Q-parity encoding step, wherein the error correction code encoding step comprises the P-parity encoding step and the Q-parity encoding step.

13. The method as claimed in claim 10, wherein the optical storage medium is a digital versatile disc (DVD), the encoding steps include an ID error detection code (IED) and error detection code (EDC) encoding step, an error correction code encoding step, a parity of the outer code (PO-parity) encoding step, and a parity of the inner code (PI-parity) encoding step, wherein the error correction code encoding step comprises the PO-parity encoding step and the PI-parity encoding step.

14. The method as claimed in claim 13, wherein the PO-parity of the PO-parity encoding step is generated according to a partial parity encoding method.

15. An apparatus for optical storage medium writing, comprising:
a primary memory, storing raw data transferred from a host; and
an encoder, coupled to the primary memory, reading the primary memory to obtain read-out data, carrying out a series of encoding steps simultaneously to generate formatted data according to the read-out data; and directly writing the formatted data to an optical storage medium without accessing the primary memory again;
wherein the raw data received by the apparatus must be converted in advance to the formatted data through the encoding steps before the formatted data is written to the optical storage medium.

16. The apparatus as claimed in claim 15, wherein the apparatus further comprises a secondary memory coupled to the encoder, and the encoder reads the primary memory in a memory access sequence to obtain the read-out data, generates partially encoded data according to the read-out data if the original memory access sequences of some of the encoding steps are different from the memory access sequence, and stores the partially encoded data in the secondary memory.

17. The apparatus as claimed in claim 15, wherein the raw data is converted to the formatted data through a scrambling step in addition to the encoding steps, and the encoder simultaneously carries out the encoding steps and the scrambling step according to the read-out data.

18. An apparatus for optical storage medium writing, comprising:
a primary memory, storing raw data transferred from a host; and
an encoder, coupled to the primary memory, receiving the raw data to obtain received data without accessing the primary memory, carrying out a series of encoding steps simultaneously according to the received data to generate formatted data, and writing the formatted data to an optical storage medium;
wherein the raw data received by the apparatus must be converted in advance to the formatted data through the encoding steps before the formatted data is written to the optical storage medium.

19. The apparatus as claimed in claim 18, wherein the apparatus obtains the received data in a data transfer sequence in which the host transfers the raw data and comprises a secondary memory coupled to the encoder, and the encoder generates partially encoded data according to the received data if original memory access sequences of some of the encoding steps are different from the data transfer sequence.
